(19) United States
(12) Patent Application Publication
(10) Pub. No.: US 2006/0243122 A1
(43) Pub. Date: Nov. 2, 2006

(54) Musical instrument mounting adapter

(76) Inventor: James Carson, Mentor, OH (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/415,018

(22) Filed: May 1, 2006

Related U.S. Application Data
(60) Provisional application No. 60/676,731, filed on May 2, 2005.

(51) Int. Cl. G10H 1/02

(52) U.S. Cl. 84/737

(57) ABSTRACT

A musical instrument mounting adapter comprising a housing and a fastener. The housing includes a base, a wall emanating from the base and a flange positioned at a distal end of the wall, the flange extending in an outward direction. The base includes an opening extending therethrough. The fastener configured for clamping at least a portion of the musical instrument between the fastener and the flange.

### CROSS-REFERENCE TO RELATED APPLICATION

This application claims priority from U.S. Provisional Patent Application Ser. No. 60/676,731 entitled “Musical Instrument Mounting Adapter” filed May 2, 2005, the entire specification of which is incorporated by reference.

### BACKGROUND OF THE INVENTION

1. Field of the Invention

The present invention relates in general to musical instruments, and more particularly to a musical instrument mounting adapter which is attachable to a musical instrument and forms the retaining structure for, for example, potentiometers. For example, the present adapter can be utilized in association with the potentiometers that are associated with electric guitars.

2. Background Art

Electric guitars have been around for many years. Typically, electric guitars include a number of potentiometers which are disposed about the top surface thereof. In many instances, these knobs extend well beyond the top surface of the guitar. As such, they may become obtrusive to the guitar player, or they may otherwise disrupt the guitar player. In other instances, the knob may be hit by an outside object inadvertently, which may undesirably alter the setting of the knob. Furthermore, when storing, packaging or otherwise moving the guitar, these obtrusive knobs may be inadvertently broken as they collide with outside objects. The potential for damage is increased with two position potentiometers which have two axial positions.

It is therefore an object of the invention to minimize the obtrusiveness of potentiometers which are disposed on the body of musical instruments.

It is another object of the invention to minimize the obtrusiveness of potentiometers which are disposed on the body of musical instruments while providing for easy adjustment of the knob by a user.

It is another object of the invention to provide for an aesthetically pleasing potentiometer on a musical instrument.

It is another object of the invention to provide for a more robust potentiometer configuration on a musical instrument.

These and other objects of the invention will become apparent in light of the specification and claims appended hereto.

### SUMMARY OF THE INVENTION

In one aspect, the invention comprises a musical instrument mounting adapter which includes a housing and a fastener. The housing includes a base, a wall emanating from the base and a flange positioned at a distal end of the wall. The flange extends in an outward direction. The base has an opening extending therethrough. The wall includes an outer surface having a threadform disposed thereon. The base and the wall collectively define a cavity. The fastener is engageable with the threadform configured for clamping at least a portion of the musical instrument between the flange and the fastener.

In a preferred embodiment, the wall comprises a substantially cylindrical configuration. In one such embodiment, the wall is substantially perpendicular to the base and the flange which are substantially parallel to each other.

In another embodiment, the flange includes a lower surface which matingly engages a beveled surface on a musical instrument. In one such embodiment, the flange includes an upper surface which is inwardly canted toward the cavity.

In yet another embodiment, the flange includes a lower surface which matingly engages a chamfered surface on a musical instrument. Preferably, the flange includes an upper surface having an outer rim and an inwardly canted surface extending from the outer rim toward the cavity.

In another aspect of the invention, the invention comprises a musical instrument mounting adapter and a potentiometer. The musical instrument adapter includes a housing and a fastener. The housing includes a base, a wall emanating from the base and a flange positioned at a distal end of the wall. The flange extends in an outward direction. The base has an opening extending therethrough. The base and the wall collectively define a cavity. The fastener is configured for clamping at least a portion of the musical instrument between the flange and the fastener. The potentiometer includes a body, a post and a knob. The post extends from the body. The post includes a threaded portion and a knob engaging portion. The post extends through the opening and a pair of opposing fasteners are threaded along the threaded portion on opposing sides of the opening to releasably couple the post to the base of the housing. The knob is positioned over the knob engaging portion.

In a preferred embodiment, the entirety of the threaded portion of the post is positioned below the distal end of the wall.

In another embodiment, the majority of the knob engaging portion is positioned below the distal end of the wall.

In a preferred embodiment, the flange includes a lower surface which matingly engages a beveled surface on a musical instrument. In one embodiment, the flange includes an upper surface which is inwardly canted toward the cavity. In one such embodiment, the knob includes a bottom surface which is convex such that it matingly follows the upper surface of the flange.

In another aspect of the invention, the flange includes a lower surface which matingly engages a chamfered surface on a musical instrument and an upper surface having an outer rim and an inwardly canted surface extending from the outer rim toward the cavity. The knob is positioned so as to have an upper surface of the flange substantially flush with the outer rim of the flange.

In yet another aspect of the invention, the invention comprises a musical instrument having a musical instrument mounting adapter and a potentiometer.

### BRIEF DESCRIPTION OF THE DRAWINGS

The invention will now be described with reference to the drawings wherein:

FIG. 1 of the drawings comprises a cross-sectional view of one embodiment of the musical instrument mounting adapter shown in an installed configuration;

FIG. 2 of the drawings comprises a cross-sectional view of a second embodiment of the musical instrument mounting adapter shown in an installed configuration;

FIG. 3 of the drawings comprises a cross-sectional view of a third embodiment of the musical instrument mounting adapter shown in an installed configuration;

FIG. 4 of the drawings comprises a top plan view of a fourth embodiment of the musical instrument mounting adapter shown in an installed configuration;

FIG. 5 of the drawings comprises a cross-sectional view of the fourth embodiment of the musical instrument mounting adapter taken generally about lines 5-5 of FIG. 4, showing the adapter in an installed configuration; and

FIG. 6 of the drawings comprises a cross-sectional view of the fifth embodiment of the musical instrument mounting adapter taken generally about lines 6-6 of FIG. 4, showing the adapter in an installed configuration; and

FIG. 7 of the drawings comprises a cross-sectional view of an embodiment of the musical instrument mounting adapter showing in particular an alternate fastener.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

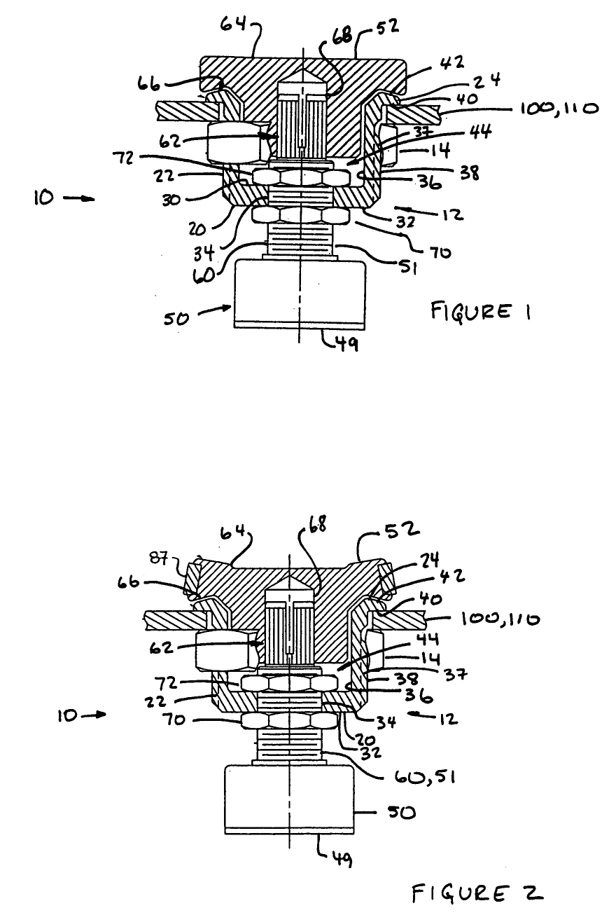

Referring now to the drawings and in particular to FIG. 1, musical instrument mounting adapter 10 is shown (hereinafter “adapter”). The adapter in generally utilized to alter the position of potentiometer 50 which is disposed on surface 110 of a musical instrument, such as musical instrument 100.

In more detail, adapter 10 includes housing 12 and fastener 14. Housing 12 includes base 20, wall 22 and flange 24. The base includes upper surface 30, lower surface 32 and opening 34. Wall 22 extends from upper surface 30 of base 20 and includes inner surface 36 and outer surface 38. Outer surface 38 of wall 22 includes a threadform 37 disposed along at least a portion thereof. The respective thickness of the base and the walls may be identical, or may be varied as desired. Flange 24 extends outwardly from the distal end of wall 22 and includes lower surface 40 and upper surface 42.

Typically, the base is substantially circular, such that the wall and the flange have a substantially circular perimeter. The base and the wall serve to define cavity 44. The cavity is substantially cylindrical with the base and the flange being substantially parallel to each other and the wall being substantially perpendicular to both. Adapter 10 may comprise a single integrated member, or may comprise a number of different components which are glued, sealed, or otherwise attached to each other.

Fastener 14 includes a threadform which matingly engages threadform 37 which is disposed on outer surface 38 of wall 22. As will be explained, the threadform in cooperation with the flange serves to clamp housing 110 of musical instrument 100 therebetween. In another embodiment, such as is shown in FIG. 7, fastener 14 may comprise a circumferential lip 85 which is spaced apart from flange 24 a distance substantially similar to the thickness of the upper surface of the guitar. When inserted into the opening in the guitar, force is used to force the lip 85 through the opening. Due to the shape of the lip 85, the lip is easily deformed to pass through the opening, but difficult to remove from the opening. By configuring the spacing accordingly, a substantially tight fit can be achieved.

To utilize the adapter, the adapter must be both coupled to the potentiometer and to the musical instrument. Depending on the particular configuration, either coupling step may be undertaken first. As such, the attachment to the potentiometer will be discussed first. The attachment to the musical instrument will be undertaken subsequently.

The potentiometer includes housing 49, post 50, knob 52 and fasteners 70, 72. Post 50 extends from housing 49 and includes threaded portion 60 and knob accepting portion 62 (commonly known as a spindle). Knob 52 includes upper surface 64, lower surface 66 and post engagement member 68. Threaded fastener 70 is positioned along the threaded portion of post 50 proximate housing 49. The potentiometer is positioned such that post 50 extends through opening 34 of base 20 of housing 12 and into cavity 44, with the potentiometer housing 49 positioned below the cavity.

Once positioned, threaded fastener 70 is moved along threaded portion 60 until the desired portion of post 50 extends into cavity 44. Once the desired orientation is achieved, threaded fastener 72 is engaged and moved along the threaded portion until the two fasteners clamp base 20. The clamping of base 20 releasably retains the potentiometer relative to the adapter. As can be seen in the figures, the entirety of the threaded portion 60 may be positioned below the instrument housing 110. It is also desirable to position a majority of the knob accepting portion 62 below the instrument housing 110.

Finally, knob 52 is attached to post 49 by interfacing post engagement member 68 of knob 52 with accepting portion 62 of post 50. Each of the post engagement member and the accepting portion include axial features such that when engaged, the two rotate in unison.

To attach the adapter to the musical instrument, the adapter is positioned within the properly sized opening of the musical instrument until the lower surface 40 of flange 24 substantially abuts instrument housing 110. Once properly positioned fastener 14 is mated to threadform 37 on outer surface 38 of wall 22 until the instrument housing is clamped between the flange and the fastener. With the embodiment of FIG. 7, it is only necessary to force lip 85 beyond the opening in the instrument housing.

As explained above, with the present adapter, the majority of the post of the potentiometer is maintained within cavity 44, and the entirety of the threaded portion of the post is positioned below the instrument housing 110, such that knob 52 is in close proximity with the musical instrument housing. Various different embodiments of the knob are shown, and it will be understood that the shape of the knob may be varied. For example, the know of FIG. 2, having the gripping portion 87, is well suited for use with two position potentiometers which can be axially moved between two different positions and rotated in either position. Indeed, even in the pulled position, only a relatively small portion of the device is outside of the instrument.

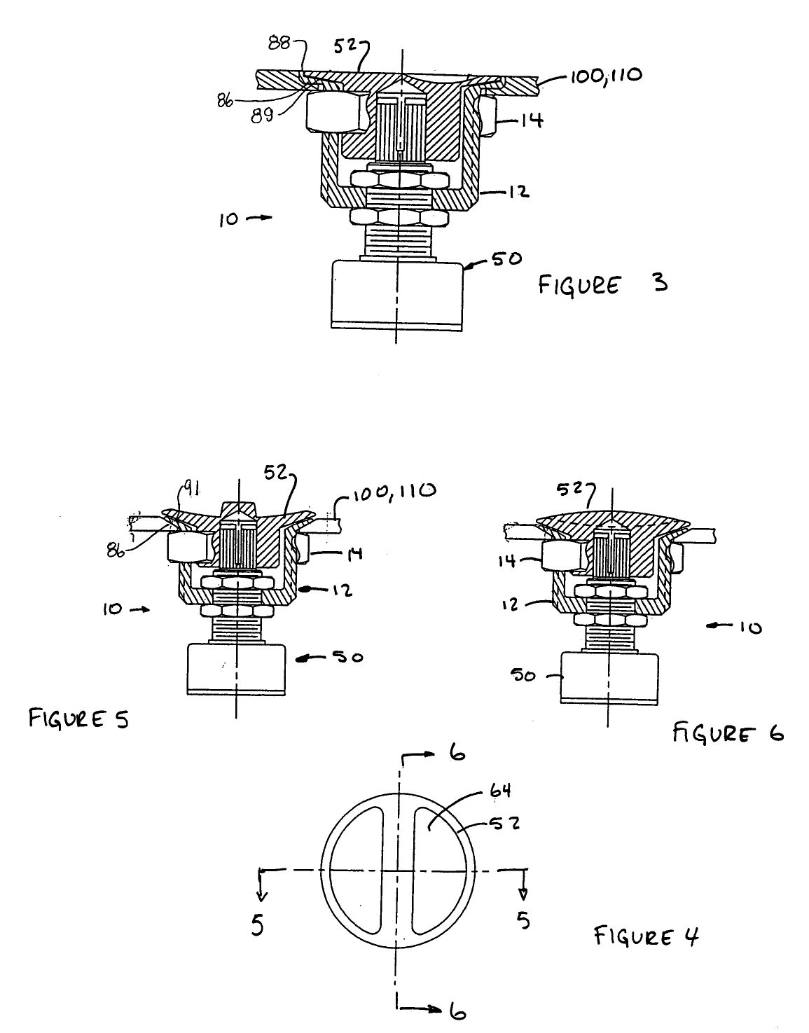

In certain embodiments, such as the embodiment shown in FIG. 3, the opening of the musical instrument may be chamfered. Additionally, the flange can be configured such that the lower surface 86 matingly engages the chamfer of the musical instrument. In addition, the upper surface of the flange includes a rim 88 and an inwardly canted surface 89 extending from the rim toward cavity 44. The rim can rest at or below the top of the musical instrument housing. The knob is then positioned below the or at the surface of the musical instrument housing. Thus, the entire potentiometer/knob assembly is flush with the musical instrument housing. In such an embodiment, the upper surface of the knob may include an indentation, or a plurality of indentations (such as a concave spherical radius) to assist a user to manipulate the knob, and, in turn, the potentiometer.

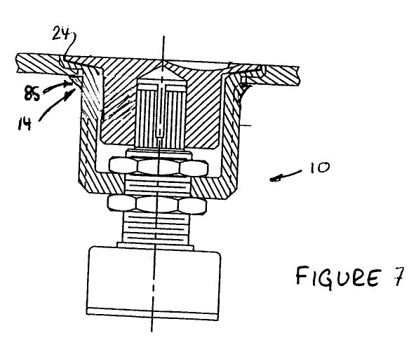

In another embodiment, such as the embodiment of FIGS. 4 through 6, the opening of the musical instrument housing may be beveled. In such an embodiment, the lower surface of the flange may be configured to matingly engage the beveled surface. Additionally, the top surface 91 thereof may likewise be beveled or otherwise angled in an inward and downward manner. The amount of the knob that protrudes beyond the musical instrument housing can be minimized. Again, the knob may be configured with features which facilitate the manipulation of the knob and the potentiometer. The bottom surface of the knob can be configured in a convex manner so that it has a shape mating interface with the top surface of the flange. Moreover, the diameter of the flange and the knob may be identical to each other such that the knob appears to float over the instrument.

It will be understood that the invention is not limited to any particular configuration of the knob. Moreover, it will be understood that the invention is not limited to any particular musical instrument, and that the description of the invention in association with an electric guitar is not to be deemed as limiting.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A musical instrument mounting adapter comprising:
a housing having a base, a wall emanating from the base and a flange positioned at a distal end of the wall, the flange extending in an outward direction, the base having an opening extending therethrough, the wall including an outer surface having a threadform disposed thereon, the base and the wall collectively defining a cavity; and
a fastener engageable with the threadform configured for clamping at least a portion of the musical instrument between the flange and the fastener.

2. The musical instrument mounting adapter of claim 1 wherein the wall comprises a substantially cylindrical configuration.

3. The musical instrument mounting adapter of claim 2 wherein the wall is substantially perpendicular to the base and the flange which are substantially parallel to each other.

4. The musical instrument mounting adapter of claim 1 wherein the flange includes a lower surface which matingly engages a beveled surface on a musical instrument.

5. The musical instrument mounting adapter of claim 4 wherein the flange includes an upper surface which is inwardly canted toward the cavity.

6. The musical instrument mounting adapter of claim 1 wherein the flange includes a lower surface which matingly engages a chamfered surface on a musical instrument.

7. The musical instrument mounting adapter of claim 6 wherein the flange includes an upper surface having an outer rim and an inwardly canted surface extending from the outer rim toward the cavity.

8. In combination, a musical instrument mounting adapter and potentiometer,
wherein the musical instrument mounting adapter comprises:
a housing having a base, a wall emanating from the base and a flange positioned at a distal end of the wall, the flange extending in an outward direction, the base having an opening extending therethrough, the base and the wall collectively defining a cavity; and
a fastener configured for clamping at least a portion of the musical instrument between the flange and the fastener; and
wherein the potentiometer comprises:
a body,
a post extending from the body, the post including a threaded portion and a knob engaging portion, the post extends through the opening and a pair of opposing fasteners are threaded along the threaded portion on opposing sides of the opening to releasably couple the post to the base of the housing; and
a knob positioned over the knob engaging portion.

9. The musical instrument mounting adapter and potentiometer combination of claim 8 wherein the entirety of the threaded portion of the post is positioned below the distal end of the wall.

10. The musical instrument mounting adapter and potentiometer combination of claim 8 wherein the majority of the knob engaging portion is positioned below the distal end of the wall.

11. The musical instrument mounting adapter and potentiometer combination of claim 8 wherein the flange includes a lower surface which matingly engages a beveled surface on a musical instrument.

12. The musical instrument mounting adapter and potentiometer combination of claim 111 wherein the flange includes an upper surface which is inwardly canted toward the cavity.

13. The musical instrument mounting adapter and potentiometer combination of claim 12 wherein the knob includes a bottom surface which is convex such that it matingly follows the upper surface of the flange.

14. The musical instrument mounting adapter and potentiometer combination of claim 11 wherein the flange includes a lower surface which matingly engages a chamfered surface on a musical instrument.

15. The musical instrument mounting adapter and potentiometer combination of claim 14 wherein the flange includes an upper surface having an outer rim and an inwardly canted surface extending from the outer rim toward the cavity.

16. The musical instrument mounting adapter and potentiometer combination of claim 15 wherein the knob is positioned so as to have an upper surface of the flange substantially flush with the outer rim of the flange.

17. The musical instrument mounting adapter and potentiometer combination of claim 8 wherein the fastener comprises a lip member spaced apart from the flange and positioned along the outer surface of the wall, configured for retaining a portion of the musical instrument therebetween.

18. A musical instrument having an instrument housing with an opening extending therethrough, a musical instrument mounting adapter and a potentiometer:
wherein the musical instrument mounting adapter comprises:
a housing having a base, a wall emanating from the base and a flange positioned at a distal end of the wall, the flange extending in an outward direction, the base having an opening extending therethrough, the base and the wall collectively defining a cavity; and
a fastener configured for clamping at least a portion of the musical instrument between the flange and the fastener; and
wherein the potentiometer comprises:
a body,
a post extending from the body, the post including a threaded portion and a knob engaging portion, the post extends through the opening and a pair of opposing fasteners are threaded along the threaded portion on opposing sides of the opening to releasably couple the post to the base of the housing; and
a knob positioned over the knob engaging portion.

19. The musical instrument of claim 18 wherein the entirety of the threaded portion of the post is positioned below the distal end of the wall.

20. The musical instrument of claim 18 wherein the majority of the knob engaging portion is positioned below the distal end of the wall.
